(19) United States
(12) Patent Application Publication
(10) Pub. No.: US 2005/0192850 A1
(43) Pub. Date: Sep. 1, 2005

(54) Systems and methods for using data structure language in web services

(76) Inventor: Scott Keith Lorenz, Cedar Park, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/790,626

(22) Filed: Mar. 1, 2004

(51) Int. Cl. G06F 17/60

(52) U.S. Cl. 705/4

(57) ABSTRACT

In various embodiments, a user may communicate with an insurance claim processing system using a data structure language message (e.g., XML messages). After assessing (e.g., parsing) a received XML message, an insurance claim processing system may perform a calculation or an action on a database. In some embodiments, calculations may include bodily injury trauma severity calculations. In some embodiments, actions may include deleting an insurance claim from the database, sending information about the insurance claim to the user system, receiving information about the insurance claim from the user system, or receiving settlement information for an insurance claim from the user system.

### BACKGROUND OF THE INVENTION

1. Field of the Invention

The present invention generally relates to computer systems. In particular, embodiments relate to systems and methods using data structure language for web services.

2. Description of the Related Art

Insurance companies are increasingly using computer systems to process and store insurance claims. Personnel involved in handling insurance claims can enter information into a computer system for later access. Computer systems can perform calculations needed for insurance claim processing. In addition, other functions associated with processing insurance claims (e.g., letter writing, keeping track of invoices, etc.) may be handled through the computer system. Personnel may also be able to use electronic mail to communicate about an insurance claim. In addition, personnel may be able to use the Internet to research different aspects of an insurance claim (e.g., find the address of an insurance claimant).

As insurance processing demands grow, insurance companies may look for more ways to outsource their insurance claim processing and storage workload. In addition, smaller insurance companies may rely on third party processing and/or storage facilities instead of expending the resources to implement their own. For insurance companies to communicate with remote facilities, a communication protocol may be needed to efficiently communicate with remote facilities over a network.

### SUMMARY OF THE INVENTION

In various embodiments, a user may interact with the insurance claim processing system through the Internet. A user may also communicate with the insurance claim processing system through other networks. In some embodiments, a data structure language (e.g., XML) may be used for communications between a user and an insurance claim processing system. While the following description describes embodiments using XML, other data structure languages, such as, but not limited to, other markup languages (e.g., hyper text markup language (HTML)) may be used in communications between a user and an insurance claim processing system. In some embodiments, the insurance claim processing system may perform functions to process insurance claims and store insurance claim data in a database.

In some embodiments, a user may interact with an insurance claim processing system through XML messages. In some embodiments, an XML message may be received from a user system and assessed (e.g., parsed). In some embodiments, an action may be performed based on information from the parsed received message. For example, a calculation related to an insurance claim may be performed or an action may be performed on a database.

In some embodiments, a user system may interface with an insurance claims processing system (e.g., to perform a calculation related to processing an insurance claim). For example, a bodily injury trauma severity calculation may be performed, and the result from performing the calculation may be returned to a user system. Other actions related to interfacing a user system with an insurance claims processing system may also be performed.

In some embodiments, an insurance claim processing system may delete data from a database (e.g., an insurance claim). In some embodiments, a message may be received from a user system including a request to delete information related to an insurance claim. In some embodiments, the received message from the user may be assessed (e.g., parsed) by the insurance claim processing system to determine which insurance claim to delete. The corresponding insurance claim may then be deleted from the database.

In various embodiments, an XML message may be used by a user system to request data from an insurance claims processing system. In some embodiments, a message may be received from a user system that includes a request to send information related to an insurance claim. In some embodiments, the received message may be parsed to identify what information should be sent. For example, an XML tag name may be used to identify data to send. The requested data may then be sent to the user system.

In some embodiments, an XML message may be used to transfer data from a user system to an insurance claim processing system. In some embodiments, a message may be received from a user system that includes a request for the insurance claim processing system to receive information for an insurance claim. In some embodiments, the received message may be parsed to identify an XML name tag and the data associated with the XML name tag to be received. In some embodiments, the corresponding data may be received from the user system and stored in a database coupled to the insurance claim processing system.

In various embodiments, information about a settlement may be sent from a user system to an insurance claim processing system. In some embodiments, a message may be received from a user system that includes a request for the insurance claim processing system to receive settlement data. In some embodiments, the received message may contain the corresponding settlement data. In some embodiments, settlement data (e.g., a settlement amount or a settlement date) may be stored in a database coupled to the insurance claim processing system.

### BRIEF DESCRIPTION OF THE DRAWINGS

A better understanding of the present invention may be obtained when the following detailed description of embodiments is considered in conjunction with the following drawings, in which:

FIG. 1 illustrates an embodiment of a wide area network (“WAN”) for use with various embodiments.

FIG. 2 illustrates an embodiment of computer system that may be suitable for implementing various embodiments of a system and method using XML.

FIG. 3 illustrates an insurance claim processing system for use with various embodiments.

FIG. 4 illustrates a flowchart of an embodiment for interactions between a user system and an insurance claim processing system using XML messages.

FIG. 5 illustrates a flowchart of an embodiment for deleting claim data from a database coupled to an insurance claim processing system.

FIG. 6 illustrates a flowchart of an embodiment for sending requested claim data to a user system.

FIG. 7 illustrates a flowchart of an embodiment for receiving claim data from a user system.

FIG. 8 illustrates a flowchart of an embodiment for receiving settlement data for an insurance claim.

FIG. 9 illustrates a flowchart of an embodiment for performing a calculation related to an insurance claim.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

U.S. patent application Ser. No. 09/603,307 titled “SYSTEM AND METHOD FOR PROCESSING INSURANCE CLAIMS USING A TABLE OF CONTENTS” filed on Jun. 23, 2000 whose inventors are Allen B. Childress and Gregory Jones is hereby incorporated by reference in its entirety as though fully and completely set forth herein.

U.S. patent application Ser. No. 09/603,129 titled “SYSTEM AND METHOD FOR IDENTIFYING CRITICAL FACTORS AFFECTING AN ESTIMATED VALUE INCLUDED IN AN INSURANCE CLAIM CONSULTATION REPORT” filed on Jun. 23, 2000 whose inventor is Gregory Jones is hereby incorporated by reference in its entirety as though fully and completely set forth herein.

U.S. patent application Ser. No. 09/603,662 titled “RELEVANCE CALCULATION FOR A REFERENCE SYSTEM IN AN INSURANCE CLAIMS PROCESSING SYSTEM” filed on Jun. 23, 2000 whose inventor is Allen B. Childress is hereby incorporated by reference in its entirety as though fully and completely set forth herein.

U.S. patent application Ser. No. 09/603,308 titled “SYSTEM AND METHOD FOR EXTERNALIZATION OF FORMULAS FOR ASSESSING DAMAGES” filed on Jun. 23, 2000 whose inventors are Brian Wolfe and Allison W. Spann is hereby incorporated by reference in its entirety as though fully and completely set forth herein.

U.S. patent application Ser. No. 09/603,144 titled “SYSTEM AND METHOD FOR EXTERNALIZATION OF RULES FOR ASSESSING DAMAGES” filed on Jun. 23, 2000 whose inventors are Gregory Jones and Allison W. Spann is hereby incorporated by reference in its entirety as though fully and completely set forth herein.

U.S. patent application Ser. No. 09/602,687 titled “WEB-ENABLED SYSTEM AND METHOD FOR ASSESSING DAMAGES” filed on Jun. 23, 2000 whose inventor is Scott Lorenz is hereby incorporated by reference in its entirety as though fully and completely set forth herein.

U.S. patent application Ser. No. 09/603,302 titled “DYNAMIC HELP SYSTEM FOR AN INSURANCE CLAIMS PROCESSING SYSTEM” filed on Jun. 23, 2000 whose inventor is Allen B. Childress is hereby incorporated by reference in its entirety as though fully and completely set forth herein.

U.S. patent application Ser. No. 09/602,691 titled “GRAPHICAL USER INTERFACE WITH A HIDE/SHOW FEATURE FOR A REFERENCE SYSTEM IN AN INSURANCE CLAIMS PROCESSING SYSTEM” filed on Jun. 23, 2000 whose inventor is Allen B. Childress is hereby incorporated by reference in its entirety as though fully and completely set forth herein.

U.S. patent application Ser. No. 09/603,130 titled “RESET BUTTON FOR WEB-ENABLED SYSTEM AND METHOD FOR ASSESSING DAMAGES” filed on Jun. 23, 2000 whose inventor is Scott Lorenz is hereby incorporated by reference in its entirety as though fully and completely set forth herein.

U.S. patent application Ser. No. 09/603,303 titled “INTERNET-ENABLED SYSTEM AND METHOD FOR ASSESSING DAMAGES” filed on Jun. 23, 2000 whose inventor is Scott Lorenz is hereby incorporated by reference in its entirety as though fully and completely set forth herein.

U.S. patent application Ser. No. 09/603,304 titled “PRICING MODELS FOR WEB-ENABLED SYSTEM AND METHOD FOR ASSESSING DAMAGES” filed on Jun. 23, 2000 whose inventor is Scott Lorenz is hereby incorporated by reference in its entirety as though fully and completely set forth herein.

U.S. patent application Ser. No. 09/603,306 titled “SYSTEM AND METHOD FOR DISPLAYING MESSAGES USING A MESSAGES TABLE” filed on Jun. 23, 2000 whose inventor is Brian Wolfe is hereby incorporated by reference in its entirety as though fully and completely set forth herein.

U.S. patent application Ser. No. 10/238,025 titled “COMPUTERIZED METHOD AND SYSTEM FOR ESTIMATING PREMISES LIABILITY FOR AN ACCIDENT” filed on Sep. 9, 2002 whose inventors are Stefan Wahlbin and Gilda Reynolds is hereby incorporated by reference in its entirety as though fully and completely set forth herein.

U.S. patent application Ser. No. 10/238,029 titled “COMPUTERIZED METHOD AND SYSTEM FOR DETERMINING CLAIMANT STATUS IN PREMISES LIABILITY FOR AN ACCIDENT” filed on Sep. 9, 2002 whose inventors are Stefan Wahibin and Gilda Reynolds is hereby incorporated by reference in its entirety as though fully and completely set forth herein.

U.S. patent application Ser. No. 10/238,019 titled “COMPUTERIZED METHOD AND SYSTEM FOR DETERMINING BREACH OF DUTY IN PREMISES LIABILITY FOR AN ACCIDENT” filed on Sep. 9, 2002 whose inventors are Stefan Wahlbin and Gilda Reynolds is hereby incorporated by reference in its entirety as though fully and completely set forth herein.

U.S. patent application Ser. No. 10/237,547 titled “COMPUTERIZED METHOD AND SYSTEM FOR DETERMINING CAUSATION IN PREMISES LIABILITY FOR AN ACCIDENT” filed on Sep. 9, 2002 whose inventors are Stefan Wahlbin and Gilda Reynolds is hereby incorporated by reference in its entirety as though fully and completely set forth herein.

U.S. patent application Ser. No. 10/238,981 titled “COMPUTERIZED METHOD AND SYSTEM FOR DETERMINING THE CONTRIBUTION OF DEFENSES TO PREMISES LIABILITY FOR AN ACCIDENT” filed on Sep. 9, 2002 whose inventors are Stefan Wahlbin and Gilda Reynolds is hereby incorporated by reference in its entirety as though fully and completely set forth herein.

U.S. patent application Ser. No. 09/969,516 titled “COMPUTERIZED METHOD AND SYSTEM OF LIABILITY ASSESSMENT FOR AN ACCIDENT” filed on Oct. 2, 2001 whose inventors are Stefan Wahlbin and Tim Johnston is hereby incorporated by reference in its entirety as though fully and completely set forth herein.

U.S. patent application Ser. No. 09/969,017 titled “COMPUTERIZED METHOD AND SYSTEM OF DETERMINING RIGHT OF WAY AND LIABILITY FOR AN ACCIDENT” filed on Oct. 2, 2001 whose inventors are Stefan Wahlbin and Tim Johnston is hereby incorporated by reference in its entirety as though fully and completely set forth herein.

U.S. patent application Ser. No. 09/969,545 titled “COMPUTERIZED METHOD AND SYSTEM OF ASSESSING AND ADJUSTING LIABILITY FOR AN ACCIDENT” filed on Oct. 2, 2001 whose inventors are Stefan Wahlbin and Tim Johnston is hereby incorporated by reference in its entirety as though fully and completely set forth herein.

U.S. patent application Ser. No. 09/969,546 titled “COMPUTERIZED METHOD AND SYSTEM OF ESTIMATING LIABILITY AND RANGE OF LIABILITY FOR AN ACCIDENT” filed on Oct. 2, 2001 whose inventors are Stefan Wahlbin and Tim Johnston is hereby incorporated by reference in its entirety as though fully and completely set forth herein.

U.S. patent application Ser. No. 09/969,015 titled “COMPUTERIZED METHOD AND SYSTEM OF DETERMINING RIGHT OF WAY IN AN ACCIDENT” filed on Oct. 2, 2001 whose inventors are Stefan Wahlbin and Tim Johnston is hereby incorporated by reference in its entirety as though fully and completely set forth herein.

U.S. patent application Ser. No. 09/969,022 titled “COMPUTERIZED METHOD AND SYSTEM OF ASSESSING LIABILITY FOR AN ACCIDENT USING IMPACT GROUPS” filed on Oct. 2, 2001 whose inventors are Stefan Wahlbin and Tim Johnston is hereby incorporated by reference in its entirety as though fully and completely set forth herein.

U.S. patent application Ser. No. 09/969,016 titled “COMPUTERIZED METHOD AND SYSTEM OF ASSIGNING AN ABSOLUTE LIABILITY VALUE FOR AN ACCIDENT” filed on Oct. 2, 2001 whose inventors are Stefan Wahlbin and Tim Johnston is hereby incorporated by reference in its entirety as though fully and completely set forth herein.

U.S. patent application Ser. No. 09/969,536 titled “COMPUTERIZED METHOD AND SYSTEM OF LIABILITY ASSESSMENT FOR AN ACCIDENT USING ENVIRONMENTAL, VEHICLE, AND DRIVER CONDITIONS AND DRIVER ACTIONS” filed on Oct. 2, 2001 whose inventors are Stefan Wahlbin and Tim Johnston is hereby incorporated by reference in its entirety as though fully and completely set forth herein.

U.S. patent application Ser. No. 09/969,534 titled “COMPUTERIZED METHOD AND SYSTEM FOR ACCUMULATING LIABILITY ESTIMATES” filed on Oct. 2, 2001 whose inventors are Stefan Wahlbin and Tim Johnston is hereby incorporated by reference in its entirety as though fully and completely set forth herein.

U.S. patent application Ser. No. 09/969,018 titled “COMPUTERIZED METHOD AND SYSTEM FOR ADJUSTING LIABILITY ESTIMATES IN AN ACCIDENT LIABILITY ASSESSMENT PROGRAM” filed on Oct. 2, 2001 whose inventors are Stefan Wahlbin and Tim Johnston is hereby incorporated by reference in its entirety as though fully and completely set forth herein.

U.S. patent application Ser. No. 09/969,019 titled “COMPUTERIZED METHOD AND SYSTEM FOR ADJUSTING LIABILITY ESTIMATION FACTORS IN AN ACCIDENT LIABILITY ASSESSMENT PROGRAM” filed on Oct. 2, 2001 whose inventors are Stefan Wahlbin and Tim Johnston is hereby incorporated by reference in its entirety as though fully and completely set forth herein.

U.S. patent application Ser. No. 09/970,161 titled “COMPUTERIZED METHOD AND SYSTEM FOR PROVIDING CLAIMS DATA TO AN ACCIDENT LIABILITY ASSESSMENT PROGRAM” filed on Oct. 2, 2001 whose inventors are Stefan Wahlbin and Tim Johnston is hereby incorporated by reference in its entirety as though fully and completely set forth herein.

U.S. patent application Ser. No. 09/969,021 titled “COMPUTERIZED METHOD AND SYSTEM OF DISPLAYING AN ACCIDENT TYPE” filed on Oct. 2, 2001 whose inventors are Stefan Wahlbin and Tim Johnston is hereby incorporated by reference in its entirety as though fully and completely set forth herein.

U.S. patent application Ser. No. 09/969,027 titled “COMPUTERIZED METHOD AND SYSTEM OF DISPLAYING A ROADWAY CONFIGURATION RELATING TO AN ACCIDENT” filed on Oct. 2, 2001 whose inventors are Stefan Wahlbin and Tim Johnston is hereby incorporated by reference in its entirety as though fully and completely set forth herein.

U.S. patent application Ser. No. 09/969,039 titled “COMPUTERIZED METHOD AND SYSTEM OF DISPLAYING AN IMPACT POINT RELATING TO AN ACCIDENT” filed on Oct. 2, 2001 whose inventors are Stefan Wahlbin and Tim Johnston is hereby incorporated by reference in its entirety as though fully and completely set forth herein.

U.S. patent application Ser. No. 09/969,020 titled “COMPUTERIZED METHOD AND SYSTEM OF DETERMINING INCONSISTENCIES IN WITNESS STATEMENTS RELATING TO AN ACCIDENT” filed on Oct. 2, 2001 whose inventors are Stefan Wahlbin and Tim Johnston is hereby incorporated by reference in its entirety as though fully and completely set forth herein.

U.S. patent application Ser. No. 09/969,146 titled “COMPUTERIZED METHOD AND SYSTEM OF IDENTIFYING A CREDIBLE WITNESS STATEMENT RELATING TO AN ACCIDENT” filed on Oct. 2, 2001 whose inventors are Stefan Wahlbin and Tim Johnston is hereby incorporated by reference in its entirety as though fully and completely set forth herein.

U.S. patent application Ser. No. 09/969,024 titled “COMPUTERIZED METHOD AND SYSTEM OF DETERMINING A CREDIBLE REAL SET OF CHARACTERISTICS FOR AN ACCIDENT” filed on Oct. 2, 2001 whose inventors are Stefan Wahlbin and Tim Johnston is hereby incorporated by reference in its entirety as though fully and completely set forth herein.

U.S. patent application Ser. No. 10/285,292 titled “GRAPHICAL DISPLAY OF BUSINESS RULES” filed on Oct. 31, 2002 whose inventors are Allen B. Childress and Allison W. Spann is hereby incorporated by reference in its entirety as though fully and completely set forth herein.

U.S. patent application Ser. No. 10/285,289 titled “METHOD OF MODIFYING A BUSINESS RULE” filed on Oct. 31, 2002 whose inventors are Allen B. Childress and Allison W. Spann is hereby incorporated by reference in its entirety as though fully and completely set forth herein.

U.S. patent application Ser. No. 10/285,339 titled “METHOD OF MODIFYING A BUSINESS RULE WHILE TRACKING THE MODIFICATIONS” filed on Oct. 31, 2002 whose inventors are Allen B. Childress and Allison W. Spann is hereby incorporated by reference in its entirety as though fully and completely set forth herein.

U.S. patent application Ser. No. 10/285,375 titled “METHOD OF FORMING A BUSINESS RULE” filed on Oct. 31, 2002 whose inventors are Allen B. Childress and Allison W. Spann is hereby incorporated by reference in its entirety as though fully and completely set forth herein.

U.S. patent application Ser. No. 10/285,338 titled “METHOD OF GENERATING A GRAPHICAL DISPLAY OF A BUSINESS RULE WITH A TRANSLATION” filed on Oct. 31, 2002 whose inventors are Allen B. Childress and Allison W. Spann is hereby incorporated by reference in its entirety as though fully and completely set forth herein.

U.S. patent application Ser. No. 10/285,293 titled “METHOD OF GENERATING A GRAPHICAL DISPLAY OF A BUSINESS RULE AND ASSOCIATED BUSINESS RULE ELEMENTS” filed on Oct. 31, 2002 whose inventors are Allen B. Childress and Allison W. Spann is hereby incorporated by reference in its entirety as though fully and completely set forth herein.

U.S. patent application Ser. No. 10/306,864 titled “COMPUTERIZED METHOD AND SYSTEM FOR ESTIMATING LIABILITY FOR AN ACCIDENT FROM AN INVESTIGATION OF THE ACCIDENT” filed on Nov. 27, 2002 whose inventors are Stefan Wahlbin, Kathleen E. Rourke, and Kimberly Wiesman is hereby incorporated by reference in its entirety as though fully and completely set forth herein.

U.S. patent application Ser. No. 10/306,873 titled “COMPUTERIZED METHOD AND SYSTEM FOR ESTIMATING LIABILITY USING DYNAMIC GENERATION OF QUESTIONS” filed on Nov. 27, 2002 whose inventors are Stefan Wahlbin, Kathleen E. Rourke, and Kimberly Wiesman is hereby incorporated by reference in its entirety as though fully and completely set forth herein.

U.S. patent application Ser. No. 10/306,909 titled “COMPUTERIZED METHOD AND SYSTEM FOR ESTIMATING AN EFFECT ON LIABILITY OF THE SPEED OF VEHICLES IN AN ACCIDENT AND TIME AND DISTANCE TRAVELED BY THE VEHICLES” filed on Nov. 27, 2002 whose inventors are Stefan Wahlbin, Kathleen E. Rourke, and Kimberly Wiesman is hereby incorporated by reference in its entirety as though fully and completely set forth herein.

U.S. patent application Ser. No. 10/306,623 titled “COMPUTERIZED METHOD AND SYSTEM FOR ESTIMATING AN EFFECT ON LIABILITY USING A COMPARISON OF THE ACTUAL SPEED OF A VEHICLE IN AN ACCIDENT AND TIME AND DISTANCE TRAVELED BY THE VEHICLES IN A MERGING VEHICLE ACCIDENT” filed on Nov. 27, 2002 whose inventors are Stefan Wahlbin, Kathleen E. Rourke, and Kimberly Wiesman is hereby incorporated by reference in its entirety as though fully and completely set forth herein.

U.S. patent application Ser. No. 10/306,803 titled “COMPUTERIZED METHOD AND SYSTEM FOR ESTIMATING AN EFFECT ON LIABILITY USING A COMPARISON OF THE ACTUAL SPEED OF VEHICLES WITH A SPECIFIED SPEED” filed on Nov. 27, 2002 whose inventors are Stefan Wahlbin, Kathleen E. Rourke, and Kimberly Wiesman is hereby incorporated by reference in its entirety as though fully and completely set forth herein.

U.S. patent application Ser. No. 10/306,908 titled “COMPUTERIZED METHOD AND SYSTEM FOR ESTIMATING AN EFFECT ON LIABILITY BASED ON THE STOPPING DISTANCE OF VEHICLES” filed on Nov. 27, 2002 whose inventors are Stefan Wahlbin, Kathleen E. Rourke, and Kimberly Wiesman is hereby incorporated by reference in its entirety as though fully and completely set forth herein.

U.S. patent application Ser. No. 10/306,804 titled “COMPUTERIZED METHOD AND SYSTEM FOR ESTIMATING AN EFFECT ON LIABILITY USING CLAIM DATA ACCESSED FROM CLAIM REPORTING SOFTWARE” filed on Nov. 27, 2002 whose inventors are Stefan Wahlbin, Kathleen E. Rourke, and Kimberly Wiesman is hereby incorporated by reference in its entirety as though fully and completely set forth herein.

U.S. patent application Ser. No. 10/306,866 titled “COMPUTERIZED METHOD AND SYSTEM FOR CREATING PRE-CONFIGURED CLAIM REPORTS INCLUDING LIABILITY IN AN ACCIDENT ESTIMATED USING A COMPUTER SYSTEM” filed on Nov. 27, 2002 whose inventors are Stefan Wahlbin, Kathleen E. Rourke, and Kimberly Wiesman is hereby incorporated by reference in its entirety as though fully and completely set forth herein.

U.S. patent application Ser. No. 10/306,858 titled “COMPUTERIZED METHOD AND SYSTEM FOR ESTIMATING LIABILITY USING RECORDED VEHICLE DATA” filed on Nov. 27, 2002 whose inventors are Stefan Wahlbin, Kathleen E. Rourke, and Kimberly Wiesman is hereby incorporated by reference in its entirety as though fully and completely set forth herein.

U.S. patent application Ser. No. 10/306,628 titled “COMPUTERIZED METHOD AND SYSTEM FOR ESTIMATING MONETARY DAMAGES DUE TO INJURIES IN AN ACCIDENT FROM LIABILITY ESTIMATED USING A COMPUTER SYSTEM” filed on Nov. 27, 2002 whose inventors are Stefan Wahlbin, Kathleen E. Rourke, and Kimberly Wiesman is hereby incorporated by reference in its entirety as though fully and completely set forth herein.

U.S. patent application Ser. No. 10/422,632 titled “GRAPHICAL INPUT DISPLAY IN AN INSURANCE PROCESSING SYSTEM” filed on Apr. 24, 2003 whose inventor is Stefan Wahlbin is hereby incorporated by reference in its entirety as though fully and completely set forth herein.

U.S. patent application Ser. No. 10/422,450 titled “METHOD AND SYSTEM FOR DETERMINING MONETARY AMOUNTS IN AN INSURANCE PROCESSING SYSTEM” filed on Apr. 24, 2003 whose inventors are Stefan L. Wahlbin and Scott C. Dulock is hereby incorporated by reference in its entirety as though fully and completely set forth herein.

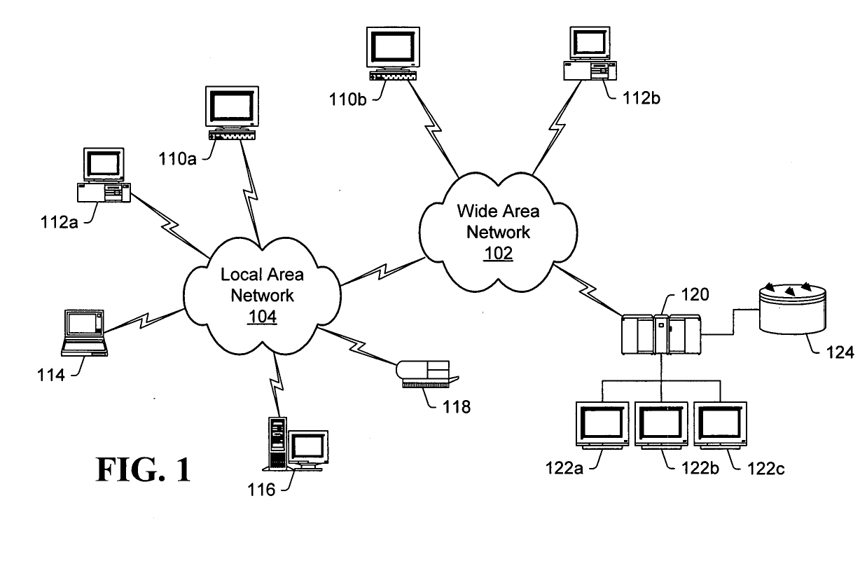

FIG. 1 illustrates an embodiment of a wide area network (“WAN”). WAN 102 may be a network that spans a relatively large geographical area. The Internet is an example of WAN 102. WAN 102 typically includes a plurality of computer systems that may be interconnected through one or more networks. Although one particular configuration is shown in FIG. 1, WAN 102 may include a variety of heterogeneous computer systems and networks that may be interconnected in a variety of ways and that may run a variety of software applications.

One or more local area networks (“LANs”) 104 may be coupled to WAN 102. LAN 104 may be a network that spans a relatively small area. Typically, LAN 104 may be confined to a single building or group of buildings. Each node (i.e., individual computer system or device) on LAN 104 may have its own CPU with which it may execute programs, and each node may also be able to access data and devices anywhere on LAN 104. LAN 104, thus, may allow many users to share devices (e.g., printers) and data stored on file servers. LAN 104 may be characterized by a variety of types of topology (i.e., the geometric arrangement of devices on the network), of protocols (i.e., the rules and encoding specifications for sending data, and whether the network uses a peer-to-peer or user/server architecture), and of media (e.g., twisted-pair wire, coaxial cables, fiber optic cables, and/or radio waves).

Each LAN 104 may include a plurality of interconnected computer systems and optionally one or more other devices such as one or more workstations 110a, one or more personal computers 112a, one or more laptop or notebook computer systems 114, one or more server computer systems 116, and one or more network printers 118. As illustrated in FIG. 1, an example LAN 104 may include one of each computer systems 110a, 112a, 114, and 116, and one printer 118. LAN 104 may be coupled to other computer systems and/or other devices and/or other LANs 104 through WAN 102.

One or more mainframe computer systems 120 may be coupled to WAN 102. As shown, mainframe 120 may be coupled to a storage device or file server 124 and mainframe terminals 122a, 122b, and 122c. Mainframe terminals 122a, 122b, and 122c may access data stored in the storage device or file server 124 coupled to or included in mainframe computer system 120.

WAN 102 may also include computer systems connected to WAN 102 individually and not through LAN 104 for purposes of example, workstation 110b and personal computer 112b. For example, WAN 102 may include computer systems that may be geographically remote and connected to each other through the Internet.

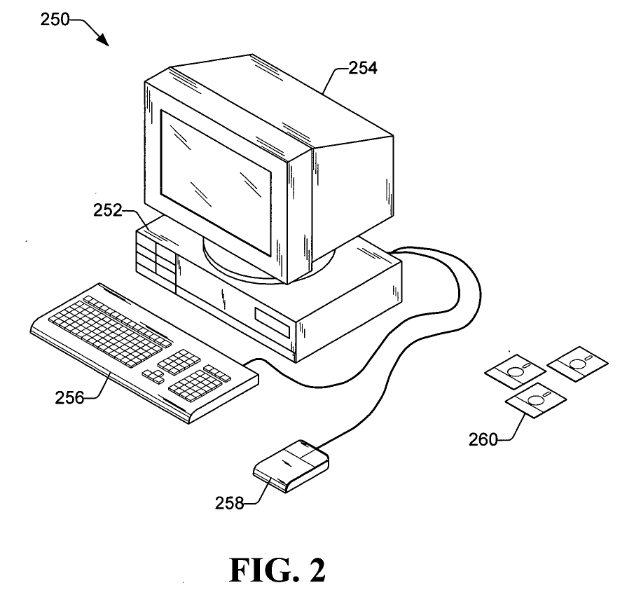

FIG. 2 illustrates an embodiment of computer system 250 that may be suitable for implementing various embodiments of a system and method using XML. Each computer system 250 typically includes components such as CPU 252 with an associated memory medium such as floppy disks 260. The memory medium may store program instructions for computer programs. The program instructions may be executable by CPU 252. Computer system 250 may further include a display device such as monitor 254, an alphanumeric input device such as keyboard 256, and a directional input device such as mouse 258. Computer system 250 may be operable to execute the computer programs to implement computer-implemented systems and methods for interpreting XML.

Computer system 250 may include a memory medium on which computer programs according to various embodiments may be stored. The term “memory medium” is intended to include an installation medium, e.g., a CD-ROM or floppy disks 260, a computer system memory such as DRAM, SRAM, EDO RAM, Rambus RAM, etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. Computer system 250 may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to implement a method for using XML. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (“MFC”), browser-based applications (e.g., Java applets), traditional programs, or other technologies or methodologies, as desired. A CPU such as host CPU 252 executing code and data from the memory medium may include a means for creating and executing the software program or programs according to the embodiments described herein.

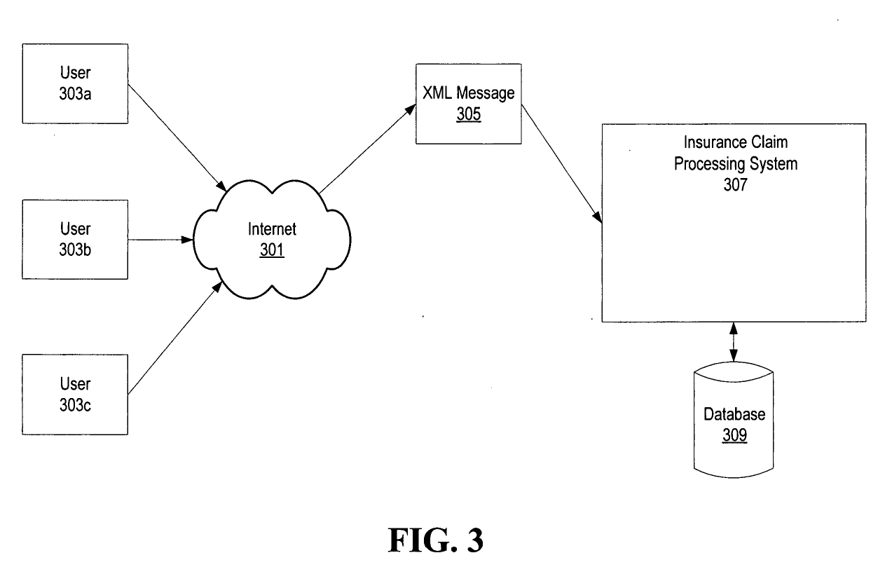

FIG. 3 illustrates an insurance claim processing system 307 for performing various embodiments. In some embodiments, a user 303 (e.g., user 303a, 303b, and 303c) (i.e., a user system) may interact with the insurance claim processing system 307 through the Internet 301. The users 303 may also communicate with the insurance claim processing system 307 through other networks. In some embodiments, a data structure language (e.g., XML) may be used for communications between a user and an insurance claim processing system. While the following description describes embodiments using XML, other data structure languages, such as, but not limited to, other markup languages (e.g., hyper text markup language (HTML)) may be used in communications between a user and an insurance claim processing system. In some embodiments, an XML message 305 may be used for communications between one or more users and the insurance claim processing system 307. For example, XML documents may be used to define a service interface. In some embodiments, two XML documents (e.g., Web Service Description Language (WSDL) and XML) may be used to define operations the user may invoke and also define the structure of XML data required for the operations. For example, WSDL may define an interface for a web service including available operations, the protocol that the user should use to invoke the web service, and the type of data the web service expects. In some embodiments, the insurance claim processing system 307 may be coupled to a database 309.

In various embodiments, the WSDL may be used to define a web service with one or more groups (e.g., a “porttype”) of related operations. The web service may also define data messages sent to and received from an operation. For example, a porttype may define an operation such as “ProcessRequest”:

```
<portType name=”PortType1”>
    <operation name=”ProcessRequest”>
        <input message=”tns:ColossusRequest”/>
        <output message=”tns:ColossusResponse”/>
    </operation>
</portType>
```

In some embodiments, a WSDL binding may describe protocol to use to invoke an operation and describe a format of input and output messages that should be used for the operation. For example, ProcessRequest's binding may use document/literal style encoding to indicate XML documents (e.g., XML messages) may be exchanged between a web service operation and a user system. One embodiment of a binding is as follows:

```
    <binding name=”ColossusSoapBinding” type=”tns:PortType1”>
        <soap:binding style=”document”
transport=”http://schemas.xmlsoap.org/soap/http”/>
        <operation name=”ProcessRequest”>
            <soap:operation
                soapAction=”colossus.insurance
claims.fsg.csc.com/action/ProcessRequest”
                style=”document”/>
            <input>
                <soap:body use=”literal”/>
            </input>
            <output>
                <soap:body use=”literal”/>
            </output>
        </operation>
    </binding>
```

Other bindings and binding formats may also be used. In some embodiments, operations requested by a user system may be specified in an XML message sent from the user system to the web service. In some embodiments, an XML file accessible by the insurance claim processing system and user system may define allowable XML messages. For example, the XML file may define data types to use in allowable XML messages between a user system and an insurance claim processing system. In some embodiments, a defined data type may be a custom defined data type or a World Wide Web Consortium (W3C) XML base data type.

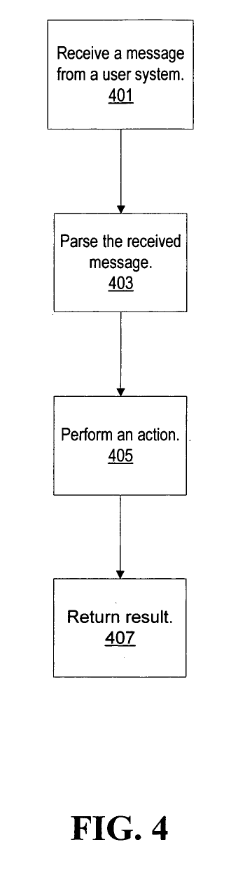

FIG. 4 illustrates a flowchart of an embodiment for interactions between a user system and an insurance claim processing system. In some embodiments, user systems may interface with insurance claim processing systems to perform a number of different insurance claim processes. For example, calculations may be performed on insurance claim data (e.g. trauma severity calculations). In some embodiments, insurance claim data may be sent, retrieved, and/or deleted. Other processes may also be performed. In some embodiments, XML messages using predefined XML schema or format may be used for communications between the user system and the insurance claim processing system.

At 401, a message from a user system may be received by an insurance claim processing system. In some embodiments, the received message may include an operation request and data associated with the operation request.

At 403, the received message may be assessed (e.g., parsed). In some embodiments, a ProcessRequest operation may parse the received message (e.g., an XML input message) to determine what function the user system is requesting. For example, the user system may request the insurance processing system perform a trauma severity calculation (e.g., a bodily injury trauma severity calculation), delete an insurance claim, retrieve an insurance claim, import an insurance claim, or update settlement information associated with an insurance claim. In some embodiments, other processes may also be performed. In some embodiments, parsing a message may include comparing the message to an expected message format to extract data. In some embodiments, parsing may include splitting a message at predetermined intervals (e.g., intervals determined using an expected message format). In some embodiments, a received message from the user system may be enclosed in a RequestMessage container element. In some embodiments, a response message from the insurance claim processing system may be enclosed in a ResponseMessage container element.

In various embodiments, the received message may be validated against an XML file. If the operation requested in the received message is unknown, or if a data type in the received message is out-of-range or invalid, an XML parse validation of the message may fail and the received message may be discarded. In some embodiments, a parser validation error may then be returned to the user system to indicate an error occurred.

At 405, an action may be performed. For example, a trauma severity calculation may be performed, or an action may be taken on a database by the insurance claim processing system. For example, an insurance claim may be imported to the database or deleted from the database. As another example, data may be retrieved from the database to be sent to a user. Other actions may also be performed. In some embodiments, the insurance claim processing system may use files (e.g., registry tables and extract files) to maintain information about insurance claims in the database.

At 407, data may be returned to the user. For example, a calculation result, requested claim data, or a confirmation that the operation was performed successfully may be sent. Other data may also be sent. In some embodiments, data may not be returned to the user after the action is performed.

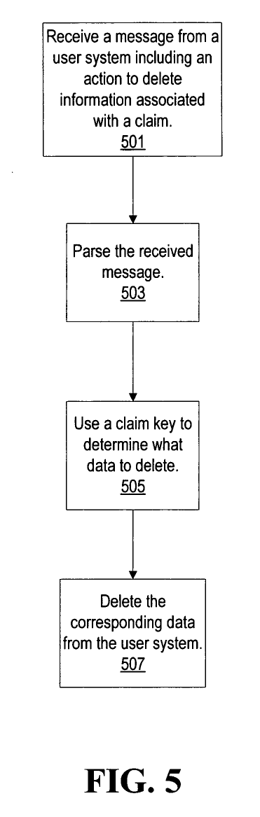

FIG. 5 illustrates a flowchart of an embodiment for deleting insurance claim data from a database coupled to an insurance claim processing system. In some embodiments, corresponding insurance claim data may also be deleted from a reporting table in an extract file maintained by the insurance claim processing system.

At 501, a message may be received from a user system that includes an action to delete information associated with an insurance claim. In some embodiments, the entire insurance claim or parts of the insurance claim may be deleted from a database coupled to the insurance claim processing system. In some embodiments, a user identifier may be sent with the message to identify a web service user system.

At 503, the message received from the user system may be parsed by the insurance claim processing system. In some embodiments, information parsed from the received message may include a requested action and corresponding insurance claim data. In some embodiments, an XML file may be used to parse the received message.

At 505, an insurance claim key in the received message may be used to determine the identity of the insurance claim to delete. In some embodiments, an insurance claim key may include a combination of an insurance claim identifier and an insurance claimant identifier.

At 507, the insurance claim may be deleted from a database coupled to the insurance claim processing system. In some embodiments, multiple insurance claims may be deleted. For example, multiple insurance claim keys may be sent in the request message for insurance claims to be deleted.

An embodiment of a received message format for deleting a claim is provided below. It is to be understood that the example represents one embodiment while the methods described herein may be performed using other program languages and formats.

```
<colossus:RequestMessage
    xmlns:colossus=”colossus.insurance claims.fsg.csc.com”
    xmlns:xsi=”http://www.w3.org/2001/XMLSchema-instance”
    xsi:schemaLocation=”colossus.insurance claims.fsg.csc.com
    Colossus.xsd “>
        <DeleteInsurance claimRequestMessage>
            <UserId>userid</UserId>
            <DeleteInsurance claimRequest>
                <Insurance claimkey>insurance claimkey</Insurance
claimkey>
            </DeleteInsurance claimRequest>
    ...can repeat if desired...
        </DeleteInsurance claimRequestMessage>
</colossus:RequestMessage>
```

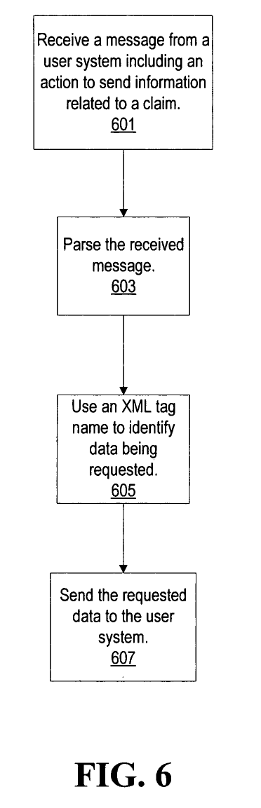

FIG. 6 illustrates a flowchart of an embodiment for sending requested insurance claim data from an insurance claim processing system to a user system.

At 601, a message may be received from a user system that includes a request for an action to send information related to an insurance claim from the insurance claim processing system to the user system. In some embodiments, specific parts of the insurance claim may be requested.

At 603, the message received from the user system may be parsed to identify the action requested and any associated data sent with the message. In some embodiments, an XML may be used to parse the received message.

At 605, an XML tag name sent in the message may be used to identify data from the insurance claim the user system is requesting. For example, an XML tag name for the data may be used by both the user system and the insurance claim system to refer to specific pieces of data. The data may then be requested using the XML tag name. In some embodiments, an XML tag name may not be specified. For example, in some embodiments, if an XML tag name is not specified, all available data about the insurance claim may be returned.

At 607, the requested data may be sent to the user system. In some embodiments, data from multiple insurance claims may be requested in a received message. In some embodiments, if an insurance claim is not found in the database, a message may be sent indicating that the insurance claim for which the data has been requested from was not found.

An embodiment of a received message format for requesting data is provided below. It is to be understood that the example represents one embodiment while the methods described herein may be performed using other program languages and formats.

```
<colossus:RequestMessage
    xmlns:colossus=”colossus.insurance claims.fsg.csc.com”
    xmlns:xsi=”http://www.w3.org/2001/XMLSchema-instance”
    xsi:schemaLocation=”colossus.insurance claims.fsg.csc.com
    Colossus.xsd “>
        <GetInsurance claimRequestMessage>
            <UserId>userid</UserId>
            <GetInsurance claimRequest>
                <Insurance claimkey>insurance claimkey</Insurance
claimkey>
            </GetInsurance claimRequest>
    ...can repeat if desired...
            <GetInsurance claimRequest>
                <Insurance claimkey>insurance claimkey</Insurance
claimkey>
                <DataToRetrieve>
                    <DataItem>dataitem</DataItem>
                    <DataItem>dataitem</DataItem>
                    <DataItem>dataitem</DataItem>
                </DataToRetrieve>
            </GetInsurance claimRequest>
        </GetInsurance claimRequestMessage>
</colossus:RequestMessage>
```

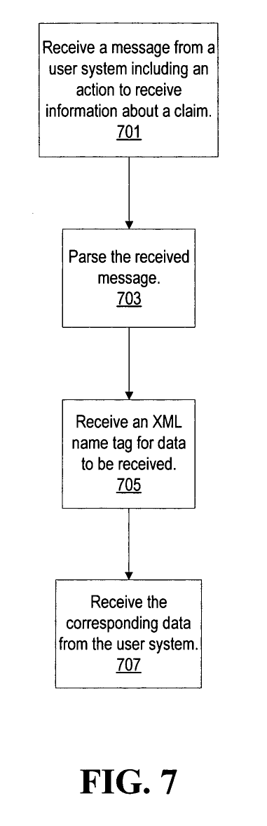

FIG. 7 illustrates a flowchart of an embodiment for receiving data from a user system. For example, insurance claim data and data from a medical bill review system may be loaded into a database. In some embodiments, if data is imported for an insurance claim that already exists in the database, the data in the database may be overwritten with the imported data. In some embodiments, the data may not be overwritten. In some embodiments, a user may designate whether previous insurance claim data should be overwritten.

At 701, a message may be received from a user system including an action to receive information about an insurance claim. For example, an insurance claim may be imported to the insurance claim processing system from the user system. In some embodiments, information about an insurance claim may be entered manually by a user of a user system and then imported to the insurance claim processing system.

At 703, the received message may be parsed to determine the action requested and identify data associated with the requested action. In some embodiments, an XML file may be used to parse the received message.

At 705, an XML name tag corresponding to the data to be received may be received from the user system. In some embodiments, the insurance claim processing system may use the XML name tag to refer to the data once stored in the database.

At 707, the corresponding data may be received from the user system. In some embodiments, data to be imported may include (insurance claimant information, insured information, adjustments, special information, and settlement information). For example, injury data (e.g., International Classification of Diseases 9^{th} ed (ICD-9) codes and provider types) may be stored for an insurance claim. In some embodiments, an ICD-9 code may be translated into a different code by the insurance claim processing system and then stored in the database. For example, additional information including side, site, or severity of an injury may be represented along with the ICD-9 code in a new code to be stored in the database. In some embodiments, injury information may be reviewed prior to being stored in the database. For example, a determination may be made as to whether a demonstrable injury exists. In some embodiments, if no demonstrable injury exists, the injury code may be ignored.

In various embodiments, treatment data may also be stored in the database for an insurance claim. For example, treatment data may include common procedural terminology (CPT) codes, treatment dates, and provider types. In some embodiments, a CPT code may be translated into a more specific code by the insurance claim processing system to be stored into the database. In some embodiments, treatment data may be reviewed before it is stored in the database. For example, a determination may be made as to the first date of treatment, the last date of treatment, and the number of visits for each provider type (e.g., general practitioner, specialist, physical therapist, and chiropractor). Some treatments may be stored as office visits. In some embodiments, treatments may be specified as initial, subsequent, or future. For example, treatments within seven days of an injury may be classified as initial treatments.

An embodiment of a received message format for data to be transmitted to the insurance claim processing system from the user system is provided below. It is to be understood that the example represents one embodiment while the methods described herein may be performed using other program languages and formats.

```
<colossus:RequestMessage
    xmlns:colossus=”colossus.insurance claims.fsg.csc.com”
    xmlns:xsi=”http://www.w3.org/2001/XMLSchema-instance”
    xsi:schemaLocation=”colossus.insurance claims.fsg.csc.com
    Colossus.xsd “>
        <ImportInsurance claimRequestMessage>
        <ForceImport>forceimport</ForceImport>
            <UserId>userid</UserId>
        <ImportInsurance claimRequest>
            <Insurance claimInfoIn>
                <Insurance claimKey>insurance
claimkey</Insurance claimkey>
                <DataItem>dataitem</DataItem>
            </Insurance claimInfoIn>
        </ImportInsurance claimRequest>
    ...can repeat if desired ...
        <ImportInsurance claimRequestMessage>
        <UserId>userid</UserId>
        <ImportInsurance claimRequest>
            <Insurance claimInfoIn>
                <Insurance claimkey>insurance
claimkey</Insurance claimkey>
                <DataItem>dataitem</DataItem>
            </Insurance claimInfoIn>
        </ImportInsurance claimRequest>
    </ImportInsurance claimRequestMessage>
</colossus:RequestMessage>
```

In some embodiments, multiple data elements from multiple insurance claims may be sent in one message. Additional messages may also be used.

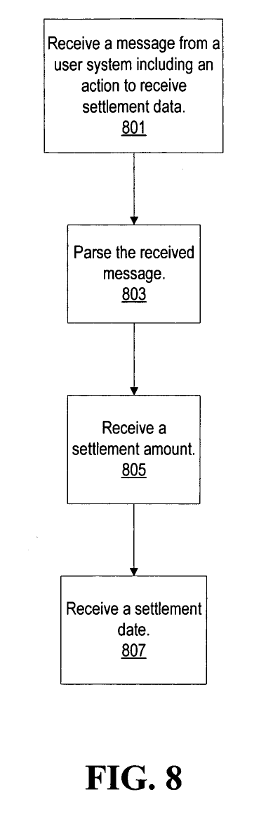

FIG. 8 illustrates a flowchart of an embodiment for receiving settlement information related to an insurance claim. For example, a settlement amount and a settlement date may be received and stored for an insurance claim. In some embodiments, settlement information may only be stored for an insurance claim that is in the database. For example, if settlement information is received for an insurance claim that does not exist, the settlement information may be ignored. In some embodiments, the settlement data may be stored for an insurance claim even if the insurance claim does not exist in the database.

At 801, a message may be received from a user system including an action to receive settlement data from the user system.

At 803, the received message may be parsed by the insurance claim processing system to determine the action requested and identify any information sent with the message. In some embodiments, an XML file may be used to parse the received message.

At 805, a settlement amount may be received. At 807, a settlement date may be received. Other settlement information may also be received.

An embodiment of a received message format for settlement information to be received from the user system is provided below. It is to be understood that the example represents one embodiment while the methods described herein may be performed using other program languages and formats.

```
<colossus:RequestMessage
    xmlns:colossus=”colossus.insurance claims.fsg.csc.com”
    xmlns:xsi=”http://www.w3.org/2001/XMLSchema-instance”
    xsi:schemaLocation=”colossus.insurance claims.fsg.csc.com
    Colossus.xsd “>
    <UpdateSettlementRequestMessage>
        <UserId>userid</UserId>
        <UpdateSettlementRequest>
            <Insurance claimkey>insurance claimkey</Insurance
            claimkey>
            <SettlementData>
                <SettlementDate>date</SettlementDate>
                <SettlementAmount>amount</SettlementAmount>
            </SettlementData>
        </UpdateSettlementRequest>
    ... can repeat if desired ...
        <UpdateSettlementRequest>
            <Insurance claimkey>insurance claimkey</Insurance
            claimkey>
            <SettlementData>
                <SettlementDate>date</SettlementDate>
                <SettlementAmount>amount</SettlementAmount>
            </SettlementData>
        </UpdateSettlementRequest>
</colossus:RequestMessage>
```

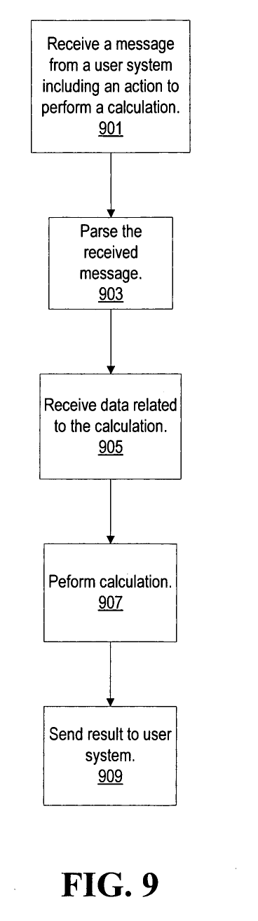

FIG. 9 illustrates a flowchart of an embodiment for performing a calculation related to an insurance claim. For example, a bodily injury trauma based calculation may be performed. In some embodiments, other calculations related to an insurance claim may also be performed.

At 901, a message may be received from a user system including an action to perform a calculation. The calculation may include any calculation performed by the insurance claims processing system.

At 903, the received message may be parsed by the insurance claim processing system to determine the calculation requested and identify any data for the calculation sent with the message. In some embodiments, an XML file may be used to parse the received message.

At 905, data related to the calculation may be received from the user system. In some embodiments, the data may be sent with the initial message, sent at a later time, or already be accessible by the insurance claims processing system.

At 907, the calculation may be performed. In some embodiments, a bodily injury trauma severity calculation may be performed. For example, the insurance claim processing system may receive information about a claim and determine a points value relative to the severity of the injury. In some embodiments, the insurance claim processing system may calculate an approximate recommended settlement value of a claim. The relevant information may be received from a user system without the user having to retype the relevant information into the insurance claim processing system. In some embodiments, the rules for determining a points value and/or a recommended settlement value may be preset by the user. In some embodiments, the rules may be preset by the insurance claims processing system.

At 909, a result may be sent to the user system. For example, the severity value and/or the recommended settlement value may be sent to the user system.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method for processing insurance claims between a user system and an insurance claim processing system, comprising:
receiving a message from the user system;
assessing the received message using a data structure language;
performing an action using the insurance claim processing system, wherein the action performed is an action requested in the received message, and wherein the action is performed in response to the insurance claim processing system receiving the message; and
returning a result of the performed action to the user system.

2. The method of claim 1, wherein the action includes a trauma severity calculation.

3. The method of claim 2, wherein the result includes a trauma severity points value.

4. The method of claim 2, wherein the result includes a recommended settlement amount.

5. The method of claim 1, wherein the action is performed on a database coupled to the insurance claim processing system for at least one insurance claim corresponding with the received message, wherein the corresponding insurance claim is identified in the parsed message.

6. The method of claim 5, wherein the action includes deleting an insurance claim from the database

7. The method of claim 5, wherein the action includes sending information about the insurance claim in the database to the user system.

8. The method of claim 5, wherein the action includes receiving information about an insurance claim to store in the database.

9. The method of claim 1, wherein performing an action includes storing settlement information for an insurance claim.

10. The method of claim 1, wherein an XML document accessible by the insurance claim processing system defines at least one of available actions, protocol to invoke an action, and an expected structure for data received in the message.

11. The method of claim 10, wherein a binding for the XML document includes at least one of the protocol and expected structure for a received message.

12. The method of claim 1, wherein the received message is in a predefined XML format.

13. The method of claim 1, further comprising sending a confirmation message that the requested action was successfully performed from the insurance claim processing system to the user system.

14. The method of claim 1, wherein if the received message is not in a predefined XML format, the received message is ignored.

15. The method of claim 1, wherein if the received message is not in a predefined XML format, an error message is returned to the user system.

16. The method of claim 1, wherein the parsed message includes an insurance claim identifier and an insurance claimant identifier.

17. The method of claim 1, wherein the action includes sending information about an insurance claim, and wherein the parsed message includes an XML tag name for a requested piece of data.

18. The method of claim 1, wherein the action comprises importing insurance claim data and wherein the received message includes an XML tag name for data to be imported.

19. The method of claim 1, wherein the action includes updating settlement information for an insurance claim in the database and wherein the data in the received message includes a settlement date and/or settlement amount.

20. The method of claim 1, wherein the data in the received message includes at least one of insurance claimant information, insured information, adjustments, and settlement information.

21. The method of claim 1, wherein data in the received message includes a diagnostic code.

22. The method of claim 1, wherein the action includes storing information about an insurance claim and wherein the information to be stored is reviewed prior to being stored in a database to determine if a demonstrable injury exists.

23. The method of claim 1, wherein the action includes retrieving information about an insurance claim, and wherein if no XML tag name is specified in the received message, substantially all of the data for the insurance claim is sent to the user system.

24. An insurance claim processing system, comprising:
a CPU;
a memory coupled to the CPU, wherein the memory comprises program instructions executable to implement:
receiving a message from the user system;
assessing the received message using a data structure language
performing an action using the insurance claim processing system, wherein the action performed is an action requested in the received message, and wherein the action is performed in response to the insurance claim processing system receiving the message; and
returning a result of the performed action to the user system.

25. The system of claim 24, wherein the action includes a trauma severity calculation.

26. The system of claim 25, wherein the result includes a trauma severity points value.

27. The system of claim 25, wherein the result includes a recommended settlement amount.

28. The system of claim 24, wherein the action is performed on a database coupled to the insurance claim processing system for at least one insurance claim corresponding with the received message, wherein the corresponding insurance claim is identified in the parsed message.

29. The system of claim 28, wherein the action includes deleting an insurance claim from the database

30. The system of claim 28, wherein the action includes sending information about the insurance claim in the database to the user system.

31. The system of claim 28, wherein the action includes receiving information about an insurance claim to store in the database.

32. The system of claim 24, wherein performing an action includes storing settlement information for an insurance claim.

33. The system of claim 24, wherein an XML document accessible by the insurance claim processing system defines at least one of available actions, protocol to invoke an action, and an expected structure for data received in the message.

34. The system of claim 33, wherein a binding for the XML document includes at least one of the protocol and expected structure for a received message.

35. The system of claim 24, wherein the received message is in a predefined XML format.

36. The system of claim 24, wherein the program instructions are further executable to implement sending a confirmation message that the requested action was successfully performed from the insurance claim processing system to the user system.

37. The system of claim 24, wherein if the received message is not in a predefined XML format, the received message is ignored.

38. The system of claim 24, wherein if the received message is not in a predefined XML format, an error message is returned to the user system.

39. The system of claim 24, wherein the parsed message includes an insurance claim identifier and an insurance claimant identifier.

40. The system of claim 24, wherein the action includes sending information about an insurance claim, and wherein the parsed message includes an XML tag name for a requested piece of data.

41. The system of claim 24, wherein the action comprises importing insurance claim data and wherein the received message includes an XML tag name for data to be imported.

42. The system of claim 24, wherein the action includes updating settlement information for an insurance claim in the database and wherein the data in the received message includes a settlement date and/or settlement amount.

43. The system of claim 24, wherein the data in the received message includes at least one of insurance claimant information, insured information, adjustments, and settlement information.

44. The system of claim 24, wherein data in the received message includes a diagnostic code.

45. The system of claim 24, wherein the action includes storing information about an insurance claim and wherein the information to be stored is reviewed prior to being stored in a database to determine if a demonstrable injury exists.

46. The system of claim 24, wherein the action includes retrieving information about an insurance claim, and wherein if no XML tag name is specified in the received message, substantially all of the data for the insurance claim is sent to the user system.

47. A carrier medium comprising program instructions, wherein the program instructions are executable to implement:
receiving a message from the user system;
assessing the received message using a data structure language;
performing an action using the insurance claim processing system, wherein the action performed is an action requested in the received message, and wherein the action is performed in response to the insurance claim processing system receiving the message; and
returning a result of the performed action to the user system.

48. The carrier medium of claim 47, wherein the action includes a trauma severity calculation.

49. The carrier medium of claim 48, wherein the result includes a trauma severity points value.

50. The carrier medium of claim 48, wherein the result includes a recommended settlement amount.

51. The carrier medium of claim 47, wherein the action is performed on a database coupled to the insurance claim processing system for at least one insurance claim corresponding with the received message, wherein the corresponding insurance claim is identified in the parsed message.

52. The carrier medium of claim 51, wherein the action includes deleting an insurance claim from the database

53. The carrier medium of claim 51, wherein the action includes sending information about the insurance claim in the database to the user system.

54. The carrier medium of claim 51, wherein the action includes receiving information about an insurance claim to store in the database.

55. The carrier medium of claim 47, wherein performing an action includes storing settlement information for an insurance claim.

56. The carrier medium of claim 47, wherein an XML document accessible by the insurance claim processing system defines at least one of available actions, protocol to invoke an action, and an expected structure for data received in the message.

57. The carrier medium of claim 56, wherein a binding for the XML document includes at least one of the protocol and expected structure for a received message.

58. The carrier medium of claim 47, wherein the received message is in a predefined XML format.

59. The carrier medium of claim 47, wherein the program instructions are further executable to implement sending a confirmation message that the requested action was successfully performed from the insurance claim processing system to the user system.

60. The carrier medium of claim 47, wherein if the received message is not in a predefined XML format, the received message is ignored.

61. The carrier medium of claim 47, wherein if the received message is not in a predefined XML format, an error message is returned to the user system.

62. The carrier medium of claim 47, wherein the parsed message includes an insurance claim identifier and an insurance claimant identifier.

63. The carrier medium of claim 47, wherein the action includes sending information about an insurance claim, and wherein the parsed message includes an XML tag name for a requested piece of data.

64. The carrier medium of claim 47, wherein the action comprises importing insurance claim data and wherein the received message includes an XML tag name for data to be imported.

65. The carrier medium of claim 47, wherein the action includes updating settlement information for an insurance claim in the database and wherein the data in the received message includes a settlement date and/or settlement amount.

66. The carrier medium of claim 47, wherein the data in the received message includes at least one of insurance claimant information, insured information, adjustments, and settlement information.

67. The carrier medium of claim 47, wherein data in the received message includes a diagnostic code.

68. The carrier medium of claim 47, wherein the action includes storing information about an insurance claim and wherein the information to be stored is reviewed prior to being stored in a database to determine if a demonstrable injury exists.

69. The carrier medium of claim 47, wherein the action includes retrieving information about an insurance claim, and wherein if no XML tag name is specified in the received message, substantially all of the data for the insurance claim is sent to the user system.
